(19) United States
(12) Patent Application Publication
(10) Pub. No.: US 2025/0283513 A1
(43) Pub. Date: Sep. 11, 2025

(54) METHODS AND SYSTEMS FOR SECURING BEARING ELEMENTS

(71) Applicant: XR Reserve, LLC, Houston, TX (US)

(72) Inventors: Gregory Prevost, Spring, TX (US); Michael R. Reese, Houston, TX (US)

(73) Assignee: XR Reserve, LLC, Houston, TX (US)

(21) Appl. No.: 19/072,343

(22) Filed: Mar. 6, 2025

Related U.S. Application Data
(60) Provisional application No. 63/562,080, filed on Mar. 6, 2024.

(51) Int. Cl. F16C 43/06; B23K 1/00; B23K 3/04; B23K 3/08

(52) U.S. Cl. CPC F16C 43/06; B23K 1/0006; B23K 1/0008; B23K 3/043; B23K 3/087

(57) ABSTRACT

Methods of securing bearing elements to bearing rings are disclosed. The methods include clamping the bearing elements in place on the bearing housing and applying heat to braze the bearing elements in place while clamped. The heat may be applied using a flame ring.

### CROSS-REFERENCE TO RELATED APPLICATIONS

The present application claims the benefit of U.S. Provisional Patent Application No. 63/562,080 (pending), filed on Mar. 6, 2024, and entitled “Methods of Securing Bearing Elements,” the entirety of which is incorporated herein by reference and made a part of the present disclosure.

### FIELD

The present disclosure relates to methods and systems for securing bearing elements, to bearings made with such methods and systems, and to systems including such bearings.

### BACKGROUND

Bearing elements are sometimes secured to a bearing ring via brazing the bearing element in place on the bearing ring. Typically, after the brazing is performed, it is necessary to perform post-brazing machining in order to more precisely position the bearing elements relative to the bearing ring and/or ensure proper tolerances in the bearing assembly. It would be desirable to have a method of securing bearing elements that more precisely positions bearing elements on a bearing ring without requiring post-brazing processing.

### BRIEF SUMMARY

Some embodiments of the present disclosure include a method of securing bearing elements to a bearing housing. The method includes positioning a plurality of bearing elements within sockets of a bearing housing, and positioning a braze material relative to the bearing elements and the bearing housing. The method includes applying a clamping force to the bearing elements to force the bearing elements into the sockets. While applying the clamping force, the method includes applying heat to the bearing elements, the braze material, and the bearing housing. The heat initiates melting of the braze material to braze the bearing elements into the sockets.

Some embodiments of the present disclosure include a bearing assembly made by the methods disclosed herein.

Some embodiments of the present disclosure include a clamp assembly for applying a clamping force to bearing elements during brazing. The clamp assembly includes a connecting rod having a first end and a second end. A first clamp is coupled with the first end of the connecting rod, and a second clamp is coupled with the second end of the connecting rod. A spring is coupled with the second end of the connecting rod such that the second clamp is positioned between the spring and the first clamp, Compression of the spring is adjustable.

Some embodiments of the present disclosure include a clamped bearing assembly for brazing. The assembly includes a bearing housing having a first end with a first bearing ring and a second end with a second bearing ring. The assembly includes a connecting rod having a first end and a second end. The connecting rod extends through the bearing housing such that the first end of the connecting rod extends from the first end of the bearing housing and the second end of the connecting rod extends from the second end of the bearing housing. A first clamp is coupled with the first end of the connecting rod, and a second clamp is coupled with the second end of the connecting rod. The first and second bearing rings are positioned between the first and second clamps. A spring is coupled with the second end of the connecting rod such that the second clamp is positioned between the spring and the second bearing ring, Compression of the spring is adjustable to apply a compression force onto the first and second bearing rings with the first and second clamps.

Some embodiments of the present disclosure include a method of securing bearing elements to a bearing ring. The method includes positioning a plurality of bearing elements on a bearing ring, positioning a braze material on the bearing elements, the bearing body, or combinations thereof, and applying a force to the bearing elements, forcing the bearing elements toward the bearing body. While applying the force, the method includes applying heat from one or more flames of a burner to the bearing elements, the braze material, the bearing body, or combinations thereof. The heat at least partially melts the braze material, brazing the bearing elements onto the bearing ring.

Some embodiments of the present disclosure include a clamp assembly for applying a clamping force to bearing elements during brazing of the bearing elements to a bearing ring. The clamp assembly includes a base plate defining a surface configured to receive a bearing ring with bearing elements. The clamp assembly includes a braze cap having an engagement surface. A spring is positioned on the braze cap such that the braze cap is positioned between the spring and the base plate. An actuator is positioned to compress the spring to apply a force to the braze cap to force the braze cap toward the base plate.

Some embodiments of the present disclosure include a flame ring for applying heat to braze bearing elements to a bearing ring. The flame ring includes a gas manifold defining a central annulus. A plurality of nozzles are in fluid communication with the gas manifold. The nozzles are positioned to direct flame from the nozzles toward the central annulus.

### BRIEF DESCRIPTION OF THE DRAWINGS

So that the manner in which the features and advantages of the assemblies, systems, and methods of the present disclosure may be understood in more detail, a more particular description briefly summarized above may be had by reference to the embodiments thereof which are illustrated in the appended drawings that form a part of this specification. It is to be noted, however, that the drawings illustrate only various exemplary embodiments and are therefore not to be considered limiting of the disclosed concepts as it may include other effective embodiments as well.

FIG. 1A is a top view of an assembly of a thrust bearing ring clamped during brazing in accordance with embodiments of the present disclosure.

FIG. 1B is a cross-sectional view of the assembly of FIG. 1A along line A-A in accordance with embodiments of the present disclosure.

FIG. 1C is a detail view of a portion of FIG. 1B showing engagement between portions of a clamp and a thrust bearing element in accordance with embodiments of the present disclosure.

FIG. 1D is a slice view of the assembly of FIG. 1A along line A-A in accordance with embodiments of the present disclosure.

FIG. 1E is a side view of the assembly of FIG. 1A in accordance with embodiments of the present disclosure.

FIG. 1F is a perspective view of the assembly of FIG. 1A in accordance with embodiments of the present disclosure.

FIG. 1G is an alternative cross-sectional view of the assembly of FIG. 1A along line A-A but with the addition of a heat shield positioned around a spring of the clamp in accordance with embodiments of the present disclosure.

FIG. 2A is a top view of an assembly of a radial bearing ring clamped during brazing in accordance with embodiments of the present disclosure.

FIG. 2B is a cross-sectional view of the assembly of FIG. 2A along line B-BA in accordance with embodiments of the present disclosure.

FIG. 2C is a detail view of a portion of FIG. 2B showing engagement between portions of a clamp and a radial bearing element.

FIG. 2D is a slice view of the assembly of FIG. 2A along line A-A in accordance with embodiments of the present disclosure.

FIG. 2E is a side view of the assembly of FIG. 2A in accordance with embodiments of the present disclosure.

FIG. 2F is a perspective view of the assembly of FIG. 2A in accordance with embodiments of the present disclosure.

FIG. 3A is a top view of an assembly of an angular bearing ring clamped during brazing in accordance with embodiments of the present disclosure.

FIG. 3B is a cross-sectional view of the assembly of FIG. 3A along line C-C in accordance with embodiments of the present disclosure.

FIG. 3C is a detail view of a portion of FIG. 3B showing engagement between portions of a clamp and an angular bearing element.

FIG. 3D is a slice view of the assembly of FIG. 3A along line C-C in accordance with embodiments of the present disclosure.

FIG. 3E is a side view of the assembly of FIG. 3A in accordance with embodiments of the present disclosure.

FIG. 3F is a perspective view of the assembly of FIG. 3A in accordance with embodiments of the present disclosure.

FIG. 4 is a schematic of a flame ring coupled with a gas/air supply in accordance with embodiments of the present disclosure.

### DETAILED DESCRIPTION

Embodiments of the present disclosure include methods and systems for securing bearing elements to bearing assemblies. The bearing elements may be thrust bearing elements, radial bearing elements, or angular bearing elements. The bearing assemblies may be or include bearing rings. The bearing elements can be secured to the bearing rings via brazing, including the application of heat to a braze material positioned adjacent the bearing elements and bearing assemblies. The heat can be provided by a flame, induction, or another heat source.

### Brazing Thrust Bearings

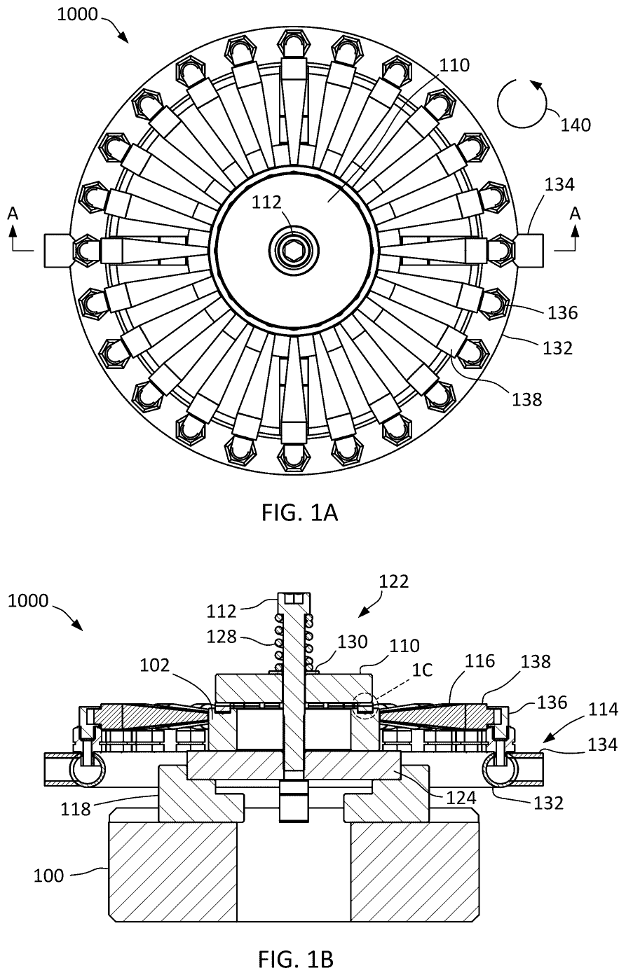

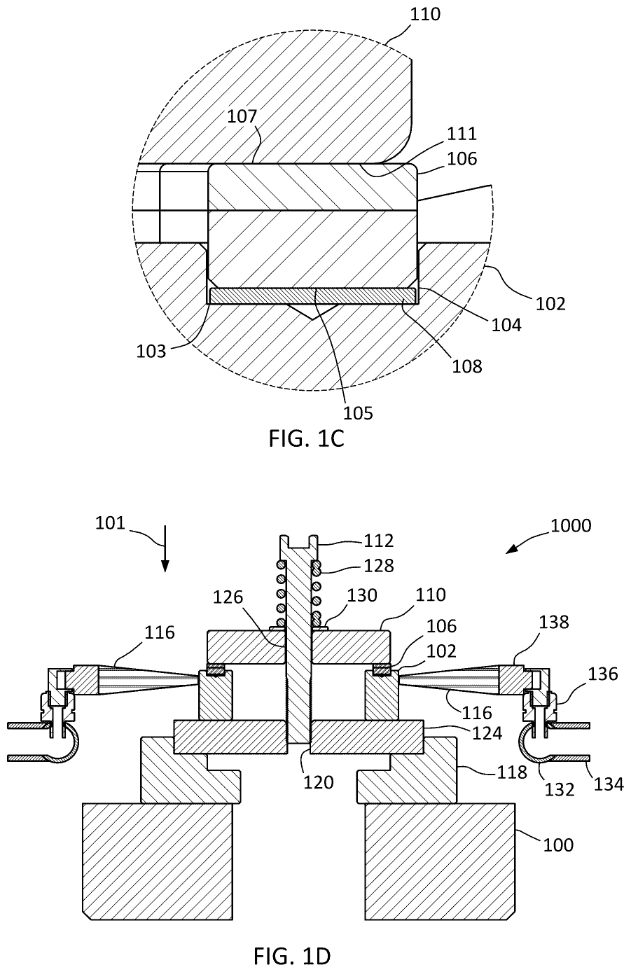

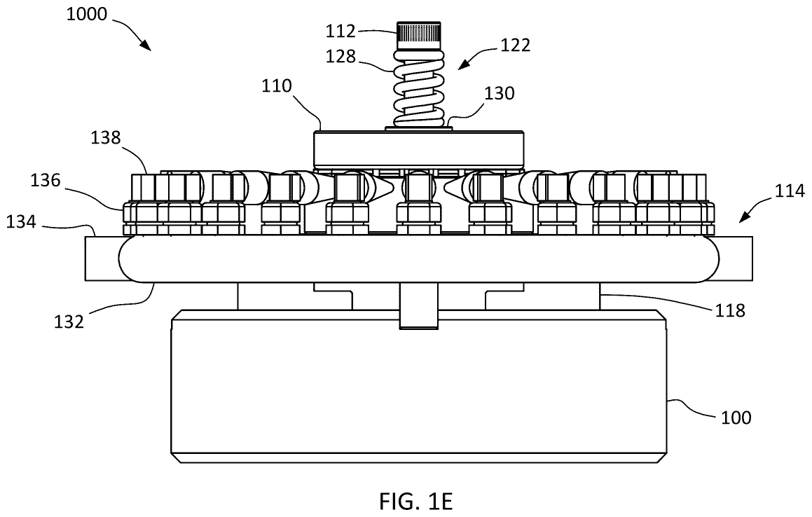

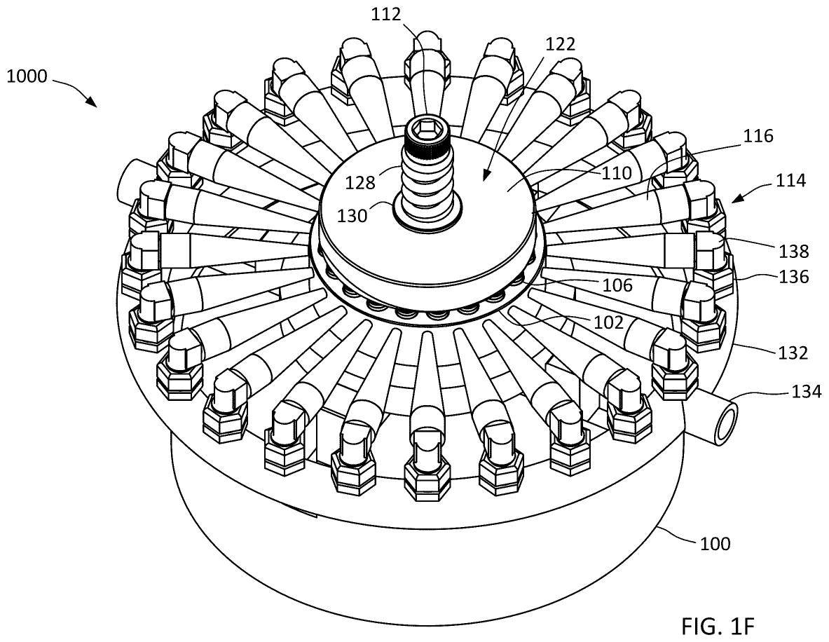

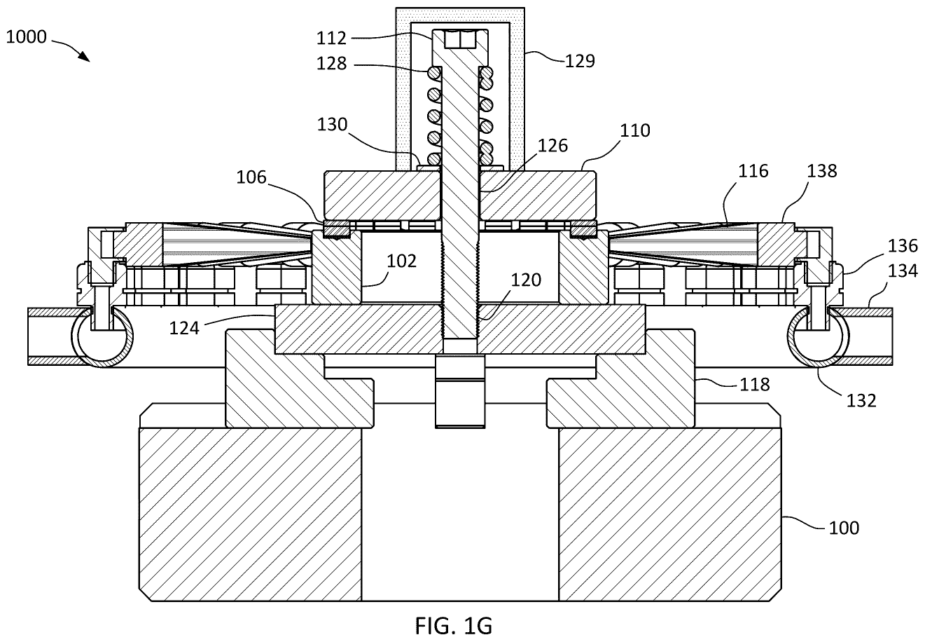

With reference to FIGS. 1A-1G, a method and system for securing thrust bearing elements to a thrust bearing ring is described. Brazing system 1000 is configured to secure a bearing ring for brazing of bearing elements thereto. In FIGS. 1A-1G, the brazing system 1000 is depicted brazing thrust bearing elements 106 to a thrust bearing ring 102. However, the brazing systems disclosed herein are not limited to use on thrust bearings and may be used on other bearings, such as radial bearings and angular bearings.

Brazing system 1000 includes a clamp assembly 122 and a flame ring 114. The clamp assembly 122 is configured to secure a position of the thrust bearing ring 102 and thrust bearing elements 106 and to apply a compressive force to the thrust bearing elements 106 during the brazing process. The flame ring 114 is configured to provide flames to heat the thrust bearing ring 102, thrust bearing elements 106, and braze material 108 to achieve the brazing of the thrust bearing elements 106 onto the thrust bearing ring 102.

The clamp assembly 122 includes a chuck 100 having a chuck jaw 118. A base plate 124 of the clamp assembly 122 is positioned and secured in the chuck jaws 118. Base plate 124 includes a threaded hole 120. The clamp assembly 122 includes a braze cap 110 having a clearance hole 126. To secure the thrust bearing ring 102 in the clamp assembly 122, the thrust bearing ring 102 is positioned onto the base plate 124. The thrust bearing ring 102 includes sockets 104 (or other receptacles) configured (e.g., shaped and sized) to receive the thrust bearing elements 106. The braze material 108 is positioned within the sockets 104 on the thrust bearing ring 102 along with an appropriate flux. The thrust bearing elements 106 are positioned within the sockets 104 such that the braze material 108 is positioned at least partially between the thrust bearing ring 102 and the thrust bearing elements 106. The thrust bearing elements 106 can be polycrystalline diamond bearing elements, such as a polycrystalline diamond compact (PDC). The braze material 108 can be a braze alloy or solder alloy in the form of a disc, paste, wire ring, or other form.

With the thrust bearing ring 102 and thrust bearing elements 106 in place, the braze cap 110 is secured over the thrust bearing ring 102. The braze cap 110 is positioned over the thrust bearing elements 106 such that the thrust bearing elements 106 are positioned between the braze cap 110 and the thrust bearing ring 102. The braze material 108 is positioned between a bottom surface 105 of the thrust bearing element 106 and a bottom surface 103 of the socket 104. A bottom surface 111 of the braze cap 110 is engaged with a top surface 107 of the thrust bearing element 106. Thus, the braze cap 110 is arranged to force the thrust bearing element 106 into the socket 104.

With the braze cap 110 in place, the braze cap 110 is secured in position via a bolt 112, spring 128, and washer 130. The bolt 112 is engaged through the spring 128, washer 130, clearance hole 126, and thrust bearing ring 102. The bolt 112 is threaded with the base plate 124 at threaded hole 120.

The clamp assembly 122 secures the thrust bearing elements 106 to the thrust bearing ring 102 during the brazing process to facilitate accurate and precise positioning of the thrust bearing elements 106 on the thrust bearing ring 102. The clamp assembly 122 exerts a force on the thrust bearing elements 106, pressing the thrust bearing elements 106 toward the thrust bearing ring 102 to maintain the thrust bearing elements 106 in position within the socket 104 during the brazing process. The direction of the force exerted onto the bearing elements 106 via the clamp assembly 122 can vary depending on the particular application and type of bearing element. In the embodiment shown in FIGS. 1A-1G, the force is in direction 101. While a clamp assembly is shown and described in the present disclosure, the methods and systems disclosed herein are not limited to use of a clamp assembly and may include other structures configured to force the bearing elements into a desired position on the bearing ring.

The bolt 112 can be tightened or loosened to increase or decrease compression forces exerted onto the spring 128, and in-turn onto the braze cap 110 and thrust bearing elements 106. Thus, the force (clamping force) applied onto the thrust bearing elements 106 during brazing can be controlled and adjusted. The clamping pressure applied to the seating face of the thrust bearing elements 106 by the clamp assembly 122 to the thrust bearing elements 106 can range from greater than 0 psi to 1,000 psi; or from 50 psi to 950 psi; or from 100 psi to 900 psi; or from 150 psi to 850 psi; or from 200 psi to 800 psi; or from 250 psi to 750 psi; or from 300 psi to 700 psi; or from 350 psi to 650 psi; or from 400 psi to 600 psi; or from 450 psi to 550 psi; or any range or discrete value therebetween. The spring 128 used in the clamp assembly 122 can be varied to vary the maximum amount of force available to be applied during the brazing process. Some exemplary springs suitable for use in certain embodiments include a spring having a maximum clamping force of 424 lbs., a spring having a maximum clamping force of 618 lbs., a spring having a maximum clamping force of 990 lbs., and a spring having a maximum clamping force of 1,634 lbs. In some embodiments, the maximum clamping force of the spring is from 300 lbs. to 2,000 lbs, or from 400 lbs. to 1,900 lbs., or from 500 lbs. to 1,800 lbs., or from 600 lbs. to 1,700 lbs., or from 700 lbs. to 1,600 lbs., or from 800 lbs. to 1,500 lbs., or from 900 lbs. to 1,400 lbs., or from 1,000 lbs. to 1,300 lbs., or from 1,100 lbs. to 1,200 lbs., or any range or discrete value therebetween. The springs are not limited to these exemplary properties and may have a maximum clamping force less than 300 lbs. or more than 2,000 lbs.

While clamping and use of a clamping assembly is described herein for applying a seating force to the bearing elements before and during the brazing, the methods disclosed herein are not limited to use of clamping and may include other methods of proving a seating force to the bearing elements. For example, the seating force can be applied to the bearing elements using weight, hydraulic force, or pneumatic force. In one embodiment, a first end of the bearing housing is placed on a surface and weight is placed on a second, opposite end such that the weight (e.g., via gravity) exerts a force on the second end and forces the first end to press against the surface, with the surface and the weight applying the seating forces to the bearing elements at the ends of the bearing housing. In another embodiment, a first end of the bearing housing is placed on a surface and hydraulic piston is coupled between the surface and a plate on the second, opposite end of the bearing housing. The hydraulic piston can actuate to move the plate towards the surface with the bearing housing positioned between the plate and the surface such that the plate exerts a force on the second end and forces the first end to press against the surface, with the surface and the plate applying the seating forces to the bearing elements at the ends of the bearing housing.

The spring 128 can be made of an alloy capable of withstanding the high-temperatures of the brazing process without melting or other structural failure occurring. For example, the spring 128 can be Inconel alloy or steel. As shown in FIG. 1G, in some embodiments, a heat shield 129 is positioned around the spring 128, such that the spring 128 is positioned between the heat shield 129 and the bolt 112. The heat shield 129 can protect the spring during brazing, preventing or reducing the flame of the brazing process from affecting the mechanical and structural integrity of the spring 128. The heat shield 129 can include a ceramic fiber material (e.g., FIBERFRAX®) wrapped around the spring 128 to help thermally insulate the spring 128 so that the flame does not heat the spring 128 sufficiently to affecting the mechanical and structural integrity of the spring 128.

With the thrust bearing ring 102 and thrust bearing elements 106 secured in place by the clamp assembly 122 at the desired compressive force, the brazing of each of the thrust bearing elements 106 can be conducted using the flame ring 114.

The flame ring 114 includes a gas manifold 132. In the depicted embodiments, the gas manifold 132 is in the shape of a ring or circle. However, the flame rings disclosed herein are not limited to having such a shape. Furthermore, while referred to as a “ring” the flame rings disclosed here may be other shapes. The flame ring 114 includes a gas inlet 134 in fluid communication with the gas manifold 132 to provide flammable gas, from a gas source (not shown), into the gas manifold 132. The flame ring 114 includes nozzle fittings 136 in fluid communication with the gas manifold 132 and configured to receive flammable gas therefrom. The flame ring 114 includes nozzles 138 are in fluid communication with the nozzle fittings 136 to receive flammable gas therefrom. The nozzles 138 can be connected with the nozzle fittings 136 via quick connects and fish tail tips connected with the nozzles 138. The nozzles 138 are posited to expel flammable gas toward the thrust bearing ring 102, thrust bearing elements 106, and braze material 108. While not depicted, the flame ring 114 may include an ignition system (e.g., spark plug) positioned to ignite the flammable gas exiting the nozzles 138 to form flames 116 or can be ignited manually with an external ignition source. The nozzles 138 can include braze tips positioned to direct the flames 116 toward a portion of thrust bearing ring 102.

The flames 116 are directed toward and/or onto the thrust bearing elements 106, braze material 108, and thrust bearing ring 102 to at least partially melt the braze material 108. The melting of the braze material 108 results in the brazing of the thrust bearing elements 106 to the thrust bearing ring 102. During the melting of the braze material 108, the spring 128 exerts a compressive force on the thrust bearing elements 106 to force the thrust bearing elements 106 to seat within the sockets 104 of the thrust bearing ring 102.

The flame ring 114 is positioned about and encircles or otherwise surrounds the thrust bearing ring 102 and includes a plurality of the nozzles 138 to substantially surround the thrust bearing ring 102 with the flames 116. The flame ring 114 and plurality of nozzles 138 can be positioned relative to the thrust bearing ring 102 such that when the flame ring 114 produces the flames 116, the flames 116 are directed to heat the thrust bearing ring 102, braze material 108, and plurality of thrust bearing elements 106 to simultaneously braze the plurality of thrust bearing elements 106 to the thrust bearing ring 102. Various aspects of the flame ring 114 can be varied to vary the amount of heat applied to the thrust bearing elements 106 such as the angles of the nozzles 138 (burners). For example, the angles of the nozzles 138 can be adjustable such that the various flames 116 impinge upon the thrust bearing ring 102 at different angles. Also, the number of nozzles 138, distance that the flames 116 extends from the nozzles 138, and gas mixture that the flame ring 114 burns can be varied. The diameter of the gas manifold 132 can be varied to accommodate for use with various sized bearing rings.

In some embodiments, during the application of the flames 116 to the thrust bearing ring 102, the thrust bearing ring 102 is rotated while the flame ring 114 is held static. With reference to FIG. 1A, the thrust bearing ring 102 can be rotated in rotational direction 140 during the brazing. Rotating the thrust bearing ring 102 can provide for a more even heating of the thrust bearing elements 106. The thrust bearing ring 102 can be rotated at from greater than 0 rpm to 1,000 rpm, from 50 to 950 rpm, from 100 to 900 rpm, from 150 to 850 rpm, from 200 to 800 rpm, from 250 to 750 rpm, from 300 to 700 rpm, from 350 to 650 rpm, from 400 to 600 rpm, from 450 to 550 rpm, or any range or discrete value therebetween. The rpm of the thrust bearing ring 102 can be constant or can vary over the duration of the brazing process. While the thrust bearing ring 102 is described as being rotated, with the flame ring 114 being held static, in other embodiments the flame ring 114 rotates and the thrust bearing ring 102 is held static. In still other embodiments, both the flame ring 114 and the thrust bearing ring 102 are rotated. The flames 116 may touch the thrust bearing ring 102 or may be spaced-apart from the thrust bearing ring 102 while still providing sufficient heat to melt the brazing material 108.

In some embodiments, the flames 116 form a reducing atmosphere in proximity to the thrust bearing ring 102, providing for less oxidation of the components of the thrust bearing ring 102. In some embodiments, the brazing is performed under vacuum (e.g., in a vacuum furnace) or in an inert gas atmosphere.

In some embodiments a temperature sensor (not shown), such as a thermocouple or IR sensor, can be used to monitor the temperature of the thrust bearing ring 102 and/or thrust bearing elements 106 during the brazing process. In some embodiments, temperature-indicating crayons are used to monitor the temperature of the thrust bearing ring 102 and/or thrust bearing elements 106 during the brazing process.

In certain embodiments, the brazing process of the thrust bearing elements 106 to the thrust bearing ring 102 can be performed in less than 10 minutes, or in 3 to 5 minutes.

Once the brazing of the thrust bearing elements 106 is completed, the clamping assembly can be removed by unthreading the bolt 112, and the thrust bearing ring 102 can be removed from the brazing system 1000. In some embodiments, after the thrust bearing elements 106 are brazed to the thrust bearing ring 102, no post-processing is performed on the brazed bearing elements 106.

The application of the clamping force by the clamping assembly 122 during the brazing provides the ability to enhance the accuracy and precision of the positioning of the thrust bearing elements 106 in the thrust bearing ring 102. For example, each thrust bearing element 106 on the thrust bearing ring 102, after brazing, can extend above a surface of the thrust bearing ring 102 to the same or substantially the same height.

### Brazing Radial Bearings

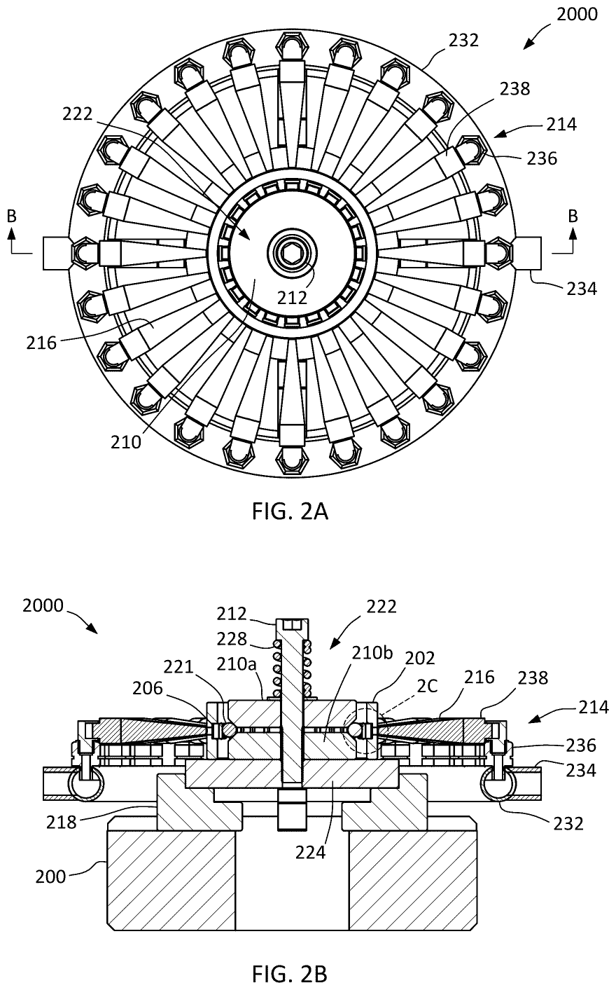

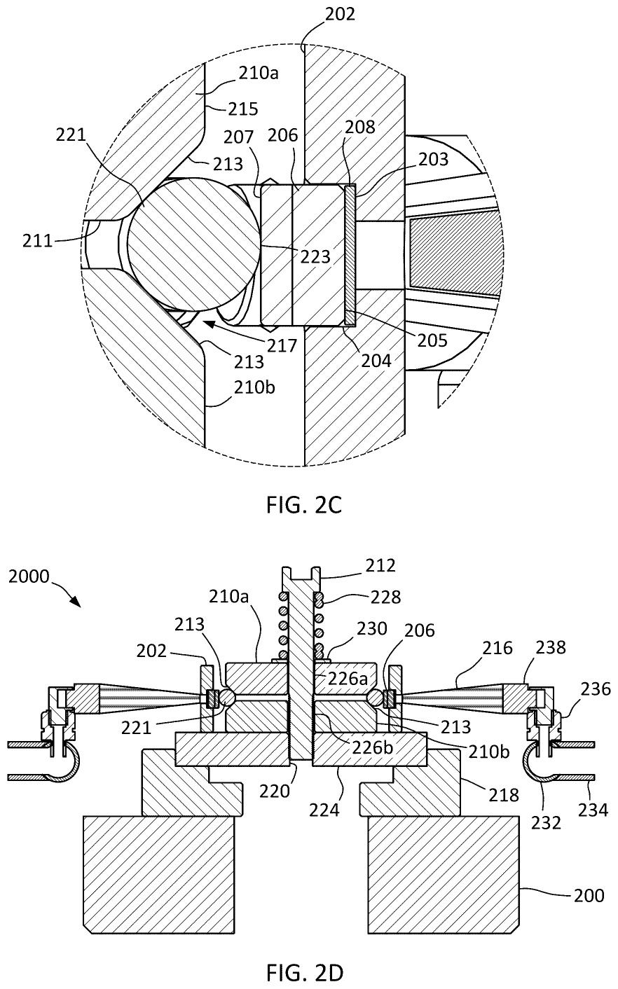

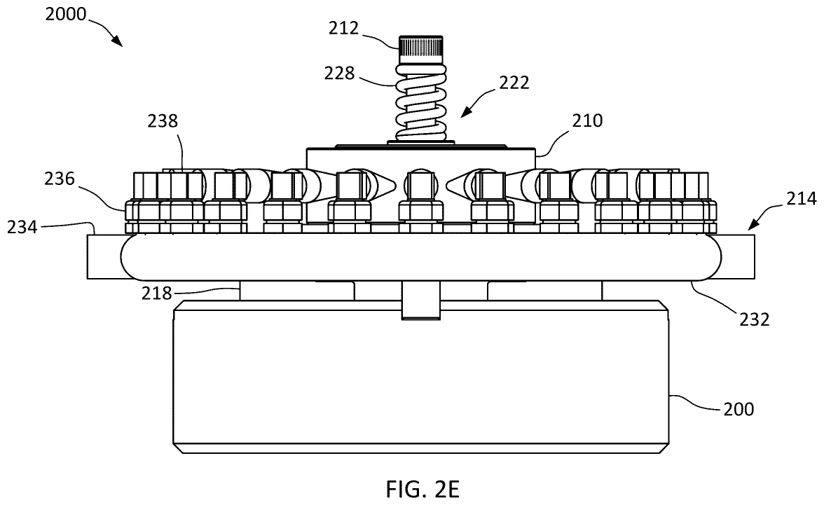

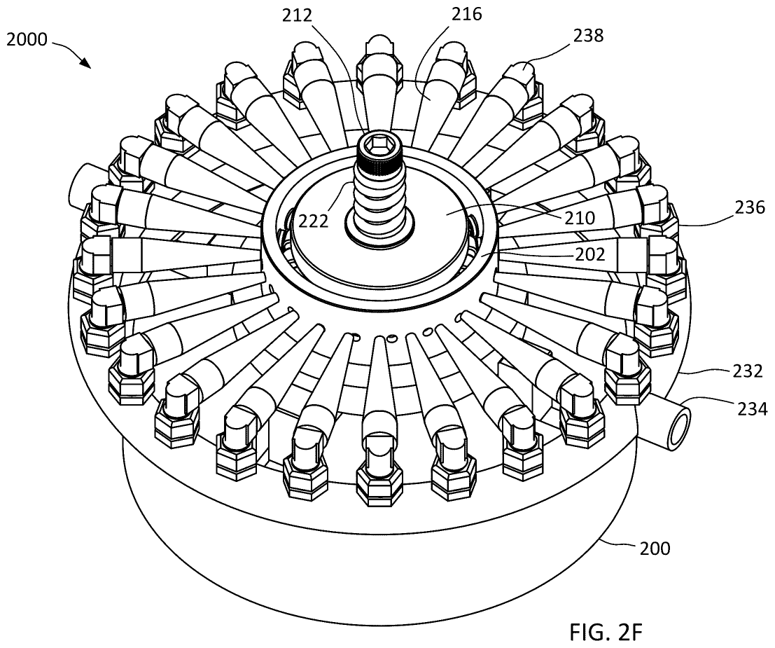

With reference to FIGS. 2A-2F, a method and system for securing radial bearing elements to a radial bearing ring is described. Brazing system 2000 is configured to secure a thrust bearing ring for brazing of the thrust bearing elements thereto. In FIGS. 2A-2F, the brazing system 2000 is depicted brazing radial bearing elements 206 to a radial bearing ring 202.

Brazing system 2000 includes a clamp assembly 222 and a flame ring 214. The clamp assembly 222 is similar to the clamp assembly 122 shown in FIGS. 1A-1G, but includes different components that are arranged to secure a position of the radial bearing ring 202 and radial bearing elements 206 and to apply a compressive force to the bearing elements 206 during the brazing process. The flame ring 214 is substantially similar, and may be identical in embodiments, to the flame ring 114 shown in FIGS. 1A-1G. Flame ring 214 is configured to provide flames to heat the radial bearing ring 202, radial bearing elements 206, and braze material 208 to achieve the brazing of the radial bearing elements 206 onto the radial bearing ring 202.

The clamp assembly 222 includes a chuck 200 having a chuck jaw 218. A base plate 224 of the clamp assembly 222 is positioned and secured in the chuck jaws 218. Base plate 224 includes a threaded hole 220. The clamp assembly 222 is different from the clamp assembly 122 at least in that rather than including only one braze cap 110, the clamp assembly 222 includes two braze caps including a first braze cap 210a having a first clearance hole 226a and a second braze cap 210b having a second clearance hole 226b. Each of the first and second braze caps 210a and 210b include an angled surface 213. For example, and without limitation, the angled surfaces 213 may be beveled surfaces, chamfered edges, or another transitional surface between the surface 211 and the side edge 215 of the braze caps 210a and 210b. A concavity 217 is defined by the angled surfaces 213 between the braze caps 210a and 210b. The clamp assembly 222 includes a radial force member 221 positioned between the radial bearing elements 206 and the braze caps 210a and 210b. The radial force member 221 is positioned at least partially in the cavity 217 and in engagement with the angled surfaces 213. The radial force member 221 is configured to translate axial forces on the braze caps 210a and 210b into radial forces directed toward the radial bearing elements 206. Prior to compression, the braze cap 210a can be spaced apart from the braze cap 210b. As the braze cap 210a is forced downward toward the braze cap 210b via force from the bolt 212 and spring 228, the angled surfaces 213 of the braze caps 210a and 210b engage the radial force member 221 and force the radial force member to push the radial bearing elements 206 to seat within the sockets 204 of the radial bearing ring 202. The radial force member 221 can be a roller, balls, wedges, or another structure configured to receive force from the braze caps 210a and 210b and direct at least a portion of the force to the radial bearing elements 206.

To secure the radial bearing ring 202 in the clamp assembly 222, the radial bearing ring 202 is positioned onto the base plate 224. The radial bearing ring 202 includes sockets 204 configured to receive the radial bearing elements 206. The braze material 208 is then positioned within sockets 204 on the radial bearing ring 202. The radial bearing elements 206 are then positioned within the sockets 204 such that the braze material 208 is positioned at least partially between the radial bearing ring 202 and the radial bearing elements 206. The braze material 208 is positioned between a bottom surface 205 of the radial bearing element 206 and a bottom surface 203 of the socket 204. A surface 223 of the radial force member 221 is engaged with a top surface 207 of the radial bearing element 206. Thus, the radial force member 221 is arranged to force the radial bearing element 206 into the socket 204.

With the radial bearing ring 202 and radial bearing elements 206 in place, the braze caps 210a and 210b are secured over the radial bearing ring 202. The radial force member 221 is positioned between the braze caps 210a and 210b and the radial bearing elements 206 such that the radial bearing elements 206 are positioned between the radial force member 221 and the radial bearing ring 202. With the braze caps 210a and 210 and radial force member 221 in place, the braze caps 210a and 210b are secured in position. In the embodiment depicted, the braze caps 210a and 210b are secured via a bolt 212, spring 228, and washer 230. The bolt 212 is engaged through the spring 228, washer 230, clearance holes 226a and 226b, and radial bearing ring 202. The bolt 212 is threaded with the base plate 224 at threaded hole 220.

The clamp assembly 222 secures the radial bearing elements 206 to the radial bearing ring 202 during the brazing process to facilitate accurate and precise positioning of the radial bearing elements 206 on the radial bearing ring 202. The bolt 212 and spring 228 exert force on the braze caps 210a and 210b, which in-turn exert forces via the angled surfaces 213 onto the radial force member 221. The radial force member 221, in-turn, exerts force onto the radial bearing elements 206, pressing the radial bearing elements 206 toward the radial bearing ring 202 to maintain the radial bearing elements 206 in position within the sockets 204 during the brazing process.

With the radial bearing ring 202 and radial bearing elements 206 secured in place by the clamp assembly 222 at the desired compressive force, the brazing of each of the radial bearing elements 206 can be conducted using the flame ring 214. Like flame ring 114, the flame ring 214 includes gas manifold 232, gas inlet 234 in fluid communication with the gas manifold 232, nozzle fittings 236 in fluid communication with the gas manifold 232, and nozzles 238 in fluid communication with the nozzle fittings 236 and configured to direct flames 216 toward the radial bearing ring 202, radial bearing elements 206, and braze material 208. 102. The flames 216 at least partially melt the braze material 208 to braze the radial bearing elements 206 to the radial bearing ring 202. As with the thrust bearing brazing, during the application of the flames 216, one or both of the radial bearing ring 202 and flame ring 214 are rotated.

Once the brazing of the radial bearing elements 206 is completed, the clamping assembly 222 can be removed by unthreading the bolt 212, and the radial bearing ring 202 can be removed from the brazing system 2000. In some embodiments, after the radial bearing elements 206 are brazed to the radial bearing ring 202, no post-processing is performed on the brazed radial bearing elements 206.

### Brazing Angular Bearings

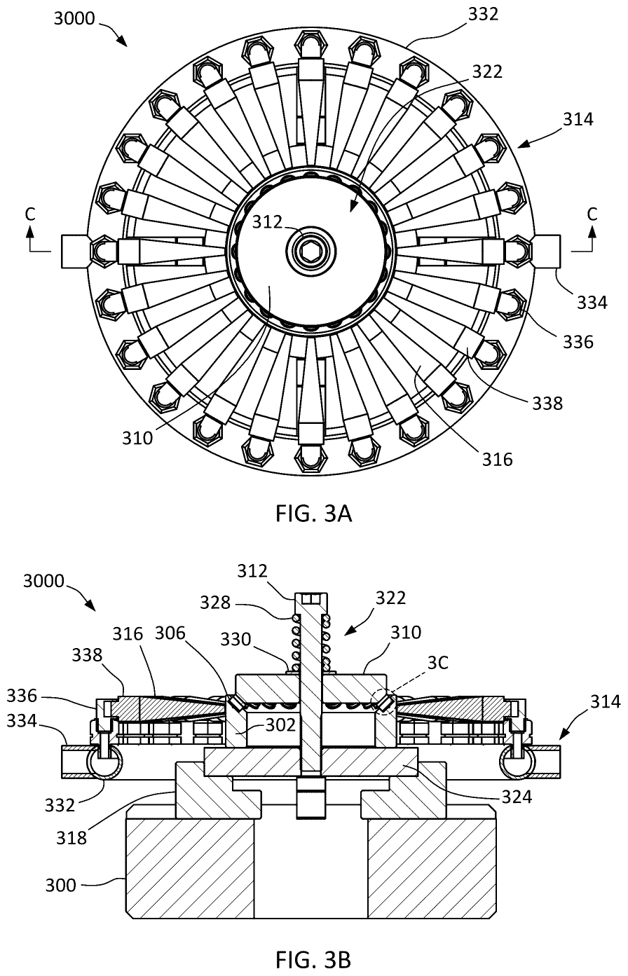

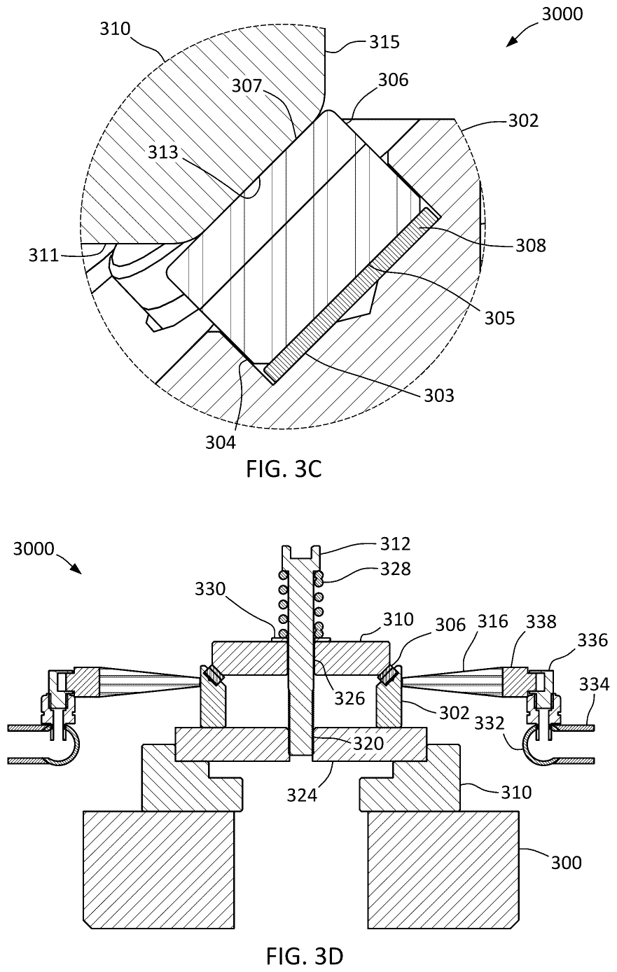

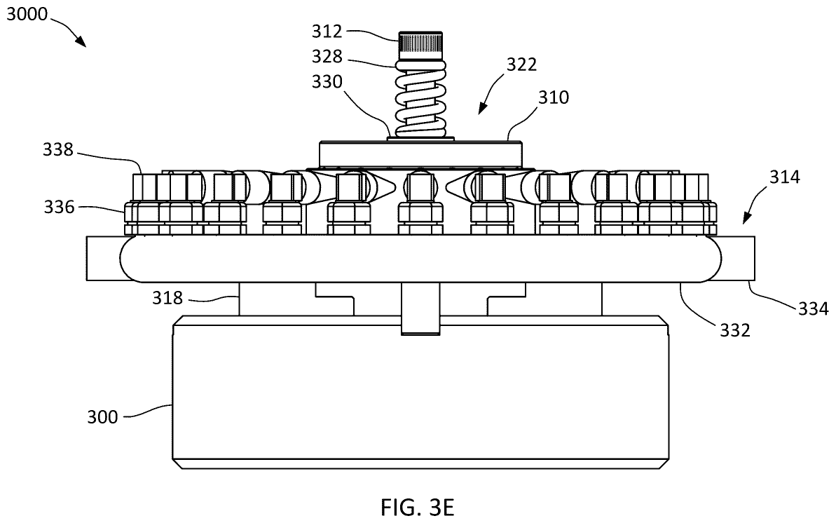

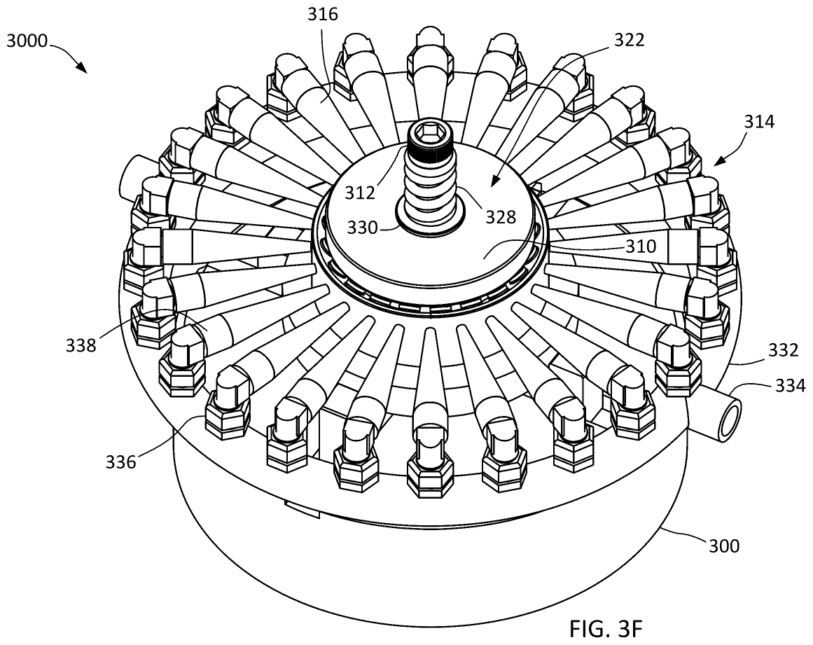

With reference to FIGS. 3A-3F, a method and system for securing angular bearing elements to an angular bearing ring is described. Brazing system 3000 is configured to secure an angular bearing ring for brazing of the angular bearing elements thereto. In FIGS. 3A-3F, the brazing system 3000 is depicted brazing angular bearing elements 306 to an angular bearing ring 302.

Brazing system 3000 includes a clamp assembly 322 and a flame ring 314. The clamp assembly 322 is similar to the clamp assembly 122 shown in FIGS. 1A-1G, but is configured to secure a position of the angular bearing ring 302 and angular bearing elements 306 and to apply a compressive force to the angular bearing elements 306 during the brazing process. The flame ring 314 is substantially similar, and may be identical in embodiments, to the flame ring 114 shown in FIGS. 1A-1G. Flame ring 314 is configured to provide flames to heat the angular bearing ring 302, angular bearing elements 306, and braze material 308 to achieve the brazing of the angular bearing elements 306 onto the angular bearing ring 302.

The clamp assembly 322 includes a chuck 300 having a chuck jaw 318. A base plate 324 of the clamp assembly 322 is positioned and secured in the chuck jaws 318. Base plate 324 includes a threaded hole 320. The clamp assembly 322 is different from the clamp assembly 322 in that the braze cap 310 includes an angled surface 313. The angled surface 313 may be a beveled surface, chamfered edge, or another transitional surface between the bottom surface 311 and the side edge 315 of the braze cap 310. The braze cap 310 includes a clearance hole 326. The angled surface 313 is configured to translate forces of the clamp assembly 322 that are directed in a axial direction into an angled direction toward the angular bearing elements 306.

To secure the angular bearing ring 302 in the clamp assembly 322, the angular bearing ring 302 is positioned onto the base plate 324. The angular bearing ring 302 includes sockets 304 configured to receive the angular bearing elements 306. The braze material 308 is then positioned within sockets 304 on the angular bearing ring 302. The angular bearing elements 306 are then positioned within the sockets 304 such that the braze material 308 is positioned at least partially between the angular bearing ring 302 and the angular bearing elements 306. The braze material 308 is positioned between a bottom surface 305 of the angular bearing element 306 and a bottom surface 303 of the socket 304. Angled surface 313 of the braze cap 310 is engaged with a top surface 307 of the angular bearing element 306. Thus, the angled surface 313 is arranged to force the angular bearing element 306 into the socket 304.

With the angular bearing ring 302 and angular bearing elements 306 in place, the braze cap 310 is secured over the angular bearing ring 302. The angular bearing elements 306 are positioned between the angled surface 313 and the angular bearing ring 302. With the braze cap 310 in place, the braze cap 310 is secured in position via a bolt 312, spring 328, and washer 330. The bolt 312 is engaged through the spring 328, washer 330, clearance hole 326, and angular bearing ring 302. The bolt 312 is threaded with the base plate 324 at threaded hole 320.

The clamp assembly 322 secures the angular bearing elements 306 to the angular bearing ring 302 during the brazing process to facilitate accurate and precise positioning of the angular bearing elements 306 on the angular bearing ring 302. The bolt 312 and spring 328 exert force on the braze cap 310, which in-turn exert forces via the angled surface 313 onto the angular bearing elements 306, pressing the angular bearing elements 306 toward the angular bearing ring 302 to maintain the angular bearing elements 306 in position within the sockets 304 during the brazing process.

With the angular bearing ring 302 and angular bearing elements 306 secured in place by the clamp assembly 322 at the desired compressive force, the brazing of each of the angular bearing elements 306 can be conducted using the flame ring 314. Like flame ring 114, the flame ring 314 includes gas manifold 332, gas inlet 334 in fluid communication with the gas manifold 332, nozzle fittings 336 in fluid communication with the gas manifold 332, and nozzles 338 in fluid communication with the nozzle fittings 336 and configured to direct flames 316 toward the angular bearing ring 302, angular bearing elements 306, and braze material 308. The flames 316 at least partially melt the braze material 308 to braze the angular bearing elements 306 to the angular bearing ring 302. As with the thrust bearing brazing, during the application of the flames 316, one or both of the angular bearing ring 302 and flame ring 314 are rotated.

Once the brazing of the angular bearing elements 306 is completed, the clamping assembly 322 can be removed by unthreading the bolt 312, and the angular bearing ring 302 can be removed from the brazing system 3000. In some embodiments, after the angular bearing elements 306 are brazed to the angular bearing ring 302, no post-processing is performed on the brazed angular bearing elements 306.

### Burner System

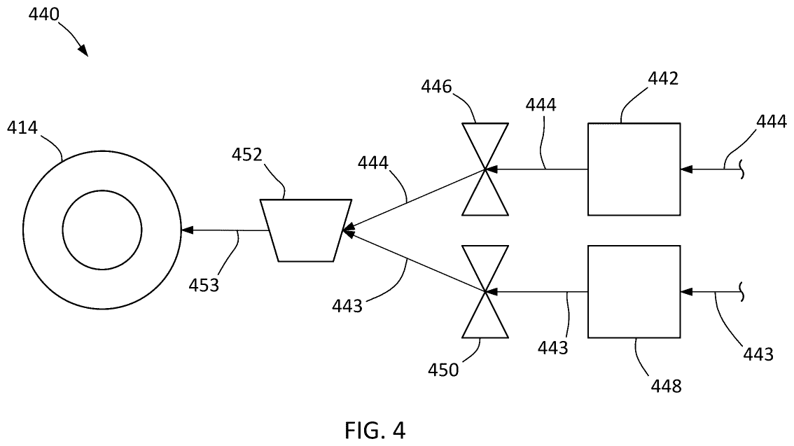

FIG. 4 is a simplified schematic of a gas/compressed air mixer system for supplying gas to the flame rings disclosed herein. Gas/compressed air mixer system 440 includes an air filter/regulator 442 for supply of air 444 (e.g., from a compressed air source). Valve 446 (e.g., air needle valve) can be used to control the amount of air 444 supplied to the flame ring. System 440 includes a zero gas governor 448 to supply flammable gas 443 (e.g., propane, natural gas) to the flame ring 414. Valve 450 (e.g., air needle valve) can be used to control the amount of gas 443 supplied to the flame ring 414. Both the gas 443 and air 444 pass through a mixer 452 (e.g., venturi mixer) for mixing of the gas 443 and air 444. The air/gas mixture 453 is directed from the mixer 452 to the burners of the flame ring 414. The gas/compressed air mixer system of FIG. 4 is only exemplary, and the system disclosed herein are not limited to this particular gas and air delivery system. The type of gas, the amount of air, the amount gas, and the proportion of gas and air in the mixture 453 can be varied to vary the flame and heat.

As the braze material melts, the spring forces the bearing elements into the sockets of the bearing ring. In some embodiments, at least some of the braze material is visible during the brazing process such that a user can visually confirm melting of the braze material. Once the brazing procedure is complete, the clamp assembly can be removed from the bearing housing.

### Induction Brazing

In some embodiments, the heat source is an induction heater instead of a flame ring. For example, in place of the flame rings shown in FIGS. 1A-3E, multi-wrap induction coils can be used to heat the bearing rings, bearing elements, braze material, and/or flux paste. The bearing elements can be positioned within sockets such that a flux paste is positioned between at least a portion of the bearing elements and at least a portion of the bearing ring. With the bearing elements secured within the sockets via a clamp assembly, a multi-wrap induction coil can be used to apply heat to the bearing elements, braze material, flux paste, and bearing ring. The application of heat from multi-wrap induction coil at least partially melts the braze material and flux paste, brazing the bearing elements to the bearing ring. The braze material flows into the space between the bearing elements and bearing ring via capillary action and gravity. The method includes ceasing the application of heat and allowing the braze material, bearing ring, and bearing elements to cool. In some embodiments, the application of induction heat is performed without rotating the bearing housing, with the bearing housing positioned on a non-rotating surface plate. The bearing elements brazed using induction heating can be angular bearings (i.e., not exclusively radial and not exclusively thrust). Prior to application of the heat and the brazing procedure, the braze material is not positioned between the bearing elements and the bearing ring.

### Applications

The brazing methods disclosed herein can be used to secure bearing elements to a variety of different types of bearing assemblies (e.g., sliding bearings) including radial bearings, thrust bearings, combined radial and thrust bearings, angular bearings, and conical bearings. The bearings may be bearings in a downhole drilling tool or motor, or other rotating part. In some embodiments, the bearing element are polycrystalline diamond compacts that include a polycrystalline diamond (PCD) table on a support (e.g., a tungsten carbide support). While the brazing methods disclosed herein are described as being used to braze bearing elements onto rotational bearings, the methods described herein are not limited to this particular application. The brazing methods can be used to apply elements to power transmission surfaces and drivelines.

Although the present embodiments and advantages have been described in detail, it should be understood that various changes, substitutions and alterations can be made herein without departing from the spirit and scope of the disclosure. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method of securing bearing elements to a bearing ring, the method comprising:
positioning a plurality of bearing elements on a bearing race of a bearing ring;
positioning a braze material on the bearing elements, the bearing body, or combinations thereof;
clamping the bearing elements and the bearing body together;
while clamping, brazing the bearing elements onto the bearing ring, wherein the brazing comprises applying heat from one or more flames of a burner to the bearing elements, the braze material, the bearing body, or combinations thereof, wherein the heat at least partially melts the braze material.

2. The method of claim 1, wherein the brazing includes surrounding the bearing ring with a plurality of flames of the burner that are directed toward the bearing ring.

3. The method of claim 1, wherein, during the brazing, the bearing ring and bearing elements are rotated relative to the burner and flames.

4. The method of claim 3, wherein the burner is maintained static while the bearing ring and bearing elements are rotated.

5. (canceled)

6. The method of claim 1, wherein the brazing is performed under vacuum.

7. The method of claim 1, wherein the burner comprises a generally ring-shaped gas manifold fluidly coupled with a supply of a gas/air mixture, wherein the bearing ring and bearing elements are positioned in an annulus of the ring-shaped gas manifold during the brazing, and wherein a plurality of flame nozzles are fluidly coupled with the ring-shaped gas manifold and positioned to direct the flames from the nozzles toward the bearing ring and bearing elements.

8. (canceled)

9. (canceled)

10. The method of claim 1, wherein the clamping comprises:
positioning the bearing ring and the bearing elements on a base plate;
positioning a braze cap over the bearing ring and the bearing elements such that the bearing ring and bearing elements are positioned between the braze cap and the base plate;
positioning a force applicator on the braze cap; and
forcing the braze cap toward to base plate with the force applicator, wherein forcing the braze cap toward the base plate clamps the bearing elements and the bearing ring together.

11. The method of claim 10, wherein the force applicator comprises a spring positioned on the braze cap such that the braze cap is positioned between the spring and the bearing ring and bearing elements, and wherein the forcing comprises compressing the spring.

12. The method of claim 11, wherein compressing the spring comprises threadably coupling a threaded end of a bolt with the base plate, wherein the bolt extends from the threaded end through the bearing ring, the braze cap, and the spring such that the spring is positioned between a bold head of the bolt and the braze cap, wherein threading the bolt towards the braze cap compresses the spring.

13. (canceled)

14. The method of claim 11, further comprising positioning a heat shield around the spring.

15. (canceled)

16. The method of claim 10, wherein:
the bearing elements are thrust bearing elements, and wherein a bottom surface of the braze cap is engaged with a top surface of the thrust bearing elements during the forcing; or
wherein the bearing elements are angular bearing elements, and wherein an angled surface of the braze cap is engaged with a top surface of the angular bearing elements during the forcing.

17. (canceled)

18. The method of claim 1, wherein the clamping comprises:
positioning the bearing ring and the bearing elements on a base plate;
positioning a first braze cap over the base plate and within an annulus of the bearing ring, wherein the first braze cap has an angled surface;
positioning a radial force member between the first braze cap and the bearing elements;
positioning a second braze cap over the first braze cap and within the annulus of the bearing ring, wherein the first and second braze caps are spaced part from one another, wherein the second braze cap has an angled surface, and wherein the radial force member is positioned between the second braze cap and the bearing elements;
positioning a force applicator on the second braze cap; and
forcing the first braze cap toward to second braze cap, wherein the angled surfaces of the braze caps engage the radial force member and force the radial force member toward the bearing elements, and wherein the radial force member engages the bearing elements and forces the bearing elements towards the bearing ring.

19. (canceled)

21. The method of claim 1, wherein, after the brazing, no lapping, polishing, grinding, or machining is performed on the brazed bearing elements.

22. (canceled)

23. The method of claim 1, comprising monitoring a temperature of the bearing ring, the bearing elements, or combinations thereof during the brazing.

24. The method of claim 1, wherein the bearing elements comprise polycrystalline diamond compacts.

25. The method of claim 1, where the bearing elements are brazed within sockets of the bearing ring.

26. The method of claim 25, wherein, prior to the brazing, the braze material is positioned outside of the sockets.

27. The method of claim 25, wherein, prior to the brazing, the braze material is positioned inside of the sockets between the bearing elements and the bearing ring.

28-42. (canceled)

43. A system for securing and heating bearing elements during brazing of the bearing elements to a bearing ring, the system comprising:
a clamp, the clamp including:
a base plate, the base plate defining a surface configured to receive a bearing ring with bearing elements;
a braze cap, the braze cap having an engagement surface;
a force applicator positioned on the braze cap;
an actuator positioned to actuate the force applicator to apply a force to the braze cap to force the braze cap toward the base plate; and
a flame ring, the flame ring including:
a gas manifold, the gas manifold defining a central annulus; and
a plurality of nozzles in fluid communication with the gas manifold, wherein the nozzles are positioned to direct flame from the nozzles toward the central annulus.

44. A method of securing bearing elements to a bearing ring, the method comprising:
positioning a bearing element on a bearing race of a bearing ring;
positioning a braze material on the bearing element, the bearing body, or combinations thereof;
clamping the bearing element and the bearing body together;
while clamping, brazing the bearing element onto the bearing ring, wherein the brazing comprises applying heat from one or more flames of a burner to the bearing element, the braze material, the bearing body, or combinations thereof, wherein the heat at least partially melts the braze material.
